(19) United States
(12) Patent Application Publication
(10) Pub. No.: US 2025/0112988 A1
(43) Pub. Date: Apr. 3, 2025

(54) A method for detecting synthetic voice and video calls

(71) Applicant: B.G. Negev Technologies and Applications Ltd., Beer Sheva (IL)

(72) Inventor: Yisroel Avraham Mirsky, Beer (IL)

(73) Assignee: B.G. Negev Technologies and Applications Ltd., Beer Sheva (IL)

(21) Appl. No.: 18/832,086

(22) PCT Filed: Jan. 23, 2023
(86) PCT No.: PCT/IB2023/050528

§ 371 Date: Jul. 22, 2024

Related U.S. Application Data
(60) Provisional application No. 63/387,690, filed on Dec. 15, 2022.
(60) Provisional application No. 63/302,086, filed on Jan. 23, 2022.

(51) Int. Cl. H04M 3/22

(52) U.S. Cl. CPC H04M 3/2281

(57) ABSTRACT

A method for preventing fake calls, the method may include receiving a call from a caller; requesting the caller to execute a deep-fake algorithm anomality triggering (DFAAT) task; receiving a caller related response to the DFAAT task; determining, based on the caller related response, whether the call is a legitimate call or a fake call, the determining includes searching for one or more deep-fake algorithm anomalies associated with the DFAAT task; performing a fake call response when determining that the call is a fake call; and performing a legitimate call response when the determining that the call is a legitimate call.

### CROSS REFERENCE

This application claims priority from U.S. provisional patent 63/302,086 filing date Jan. 23 2022 which is incorporated herein by reference.

This application claims priority from U.S. provisional patent 63/387,690 filing date Dec. 15, 2022 which is incorporated herein by reference

### BACKGROUND

A deepfake is any media, generated by a deep neural network, which is authentic from a human being's perspective. Since the emergence of deepfakes in 2017, the technology has improved in terms of quality and has been adopted in a variety of applications. For example, deepfake technology is used to enhance productivity, education and provide entertainment. However, the same technology has been used for unethical and malicious purposes as well. For example, with a deepfake, anyone can impersonate a target identity by reenacting the target's face and/or voice. This ability has enabled threat actors to perform defamation, blackmail, misinformation, and social engineering attacks on companies and individuals around the world.

For example, since 2017, the technology has been used to ‘swap’ the identity of individuals into explicit videos for unethical and malicious reasons. More recently, in March 2022 during the Russian-Ukraine conflict, a deepfake video was circulated depicting the prime minister of Ukraine telling his troops to give up and stop fighting.

### Real-Time Deepfakes (RT-DF)

Deepfake technology has improved over the last few years in terms of efficiency. This has enabled attackers to create real-time deepfakes

With an RT-DF, an attacker can impersonate people over voice and video calls. The danger of this emerging threat is that (1) the attack vector is not expected, (2) familiarity can be mistaken as authenticity and (3) the quality of RT-DFs is constantly improving.

To conceptualize this threat, let's perform the following thought experiment. Imagine someone receives a call from their mother who is in trouble and urgently needs a money transfer. The caller sounds exactly like her, but the situation seems a bit out of place. Under stress and frustration, she hands the phone over to someone who sounds like the victim's father, who confirms the situation. Without hesitation, many would transfer the money even though they're technically talking to a stranger.

Now consider state-actors with considerable amounts of time and resources. They could target workers at power plants and other critical infrastructure by posing as their administrators. Over a phone call, they could convince the worker to change a configuration or reveal confidential information which would lead to a cyber breach or a catastrophic failure. Attackers could even pose as military officials or politicians leading to a breach of national security.

These scenarios are plausible because some existing real-time frameworks can impersonate an individual's face or voice using very little information. For example, some real-time methods can reenact a face with one sample image and some can clone a voice with just a few seconds of audio. Using these technologies, an attacker would only need to call the source voice for a few seconds or scrape the source's image from the internet to perform the attack.

### The Emerging Threat of RT-DFs

Threat actors already understand the utility of RT-DFs. This is evident in recent events where RT-DFs have been used to perform criminal acts. The first case was discovered in 2019 when a CEO was tricked into transferring 243k due to an RT-DF phone call. In 2021, senior European MPs participated in Zoom meetings with someone masquerading as Russian opposition figures. In the same year, cyber criminals pulled off a 35 million bank heist involving RT-DF audio calls to a company director, tricking him to perform money transfers. In June 2022, the FBI released a warning that cyber criminals are using RT-DFs in job interviews in order to secure remote work positions and gain insider information. Then in August that year, cyber criminals attended Zoom meetings masquerading as the CEO of Binance.

### The Gap in Current Defenses

Many methods have been proposed for detecting deepfakes. These methods typically use deep learning models to either (1) detect mistakes or artifacts in generated media, or (2) search for forensic evidence such as a latent noise patterns. However, there are two fundamental problems with existing defenses:

Longevity. Methods which identify semantic errors or artifacts have the assumption that the quality of deepfakes will not significantly improve. However, it is clearly evident that the quality of deepfakes is improving and at a fast rate. Therefore, artifact-based methods have a high potential of becoming obsolete within a short time-frame.

Evasion. Methods which rely on latent noise patterns can be evaded by applying a post-processor. For example a deepfake can be passed through a low pass filter, undergo compression or be given additive noise. Moreover, these processes are common in audio and video calls. Therefore, the attacker may not need to do anything to remove the forensic evidence in the call.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a fake call defense scenario;

FIG. 2 illustrates an example of a first table;

FIG. 3 illustrates an example of a deep fake algorithm anomality based protection (DFAABP) system;

FIG. 4 illustrates an example of an example of a DFAABP system;

FIG. 5 illustrates an example of a DFAABP system;

FIG. 6 illustrates an example of a method;

FIG. 7 illustrates an example of a method;

FIG. 8 illustrates an example of a method;

FIG. 9 illustrates an example of a RT-DF distribution of ratings;

FIG. 10 illustrates an example of a RT-DF quality;

FIG. 11 illustrates an example of a RT-DF identity;

FIG. 12 illustrates an example of a second table;

FIG. 13 illustrates an example of a performance of a task detection model;

FIG. 14 illustrates an example of a performance of an unsupervised identity detection model;

FIG. 15 illustrates an example of a DFAABP system performance;

FIG. 16 illustrates an example of a third table; and

FIGS. 17-18 illustrate examples of prevention of a fake calls.

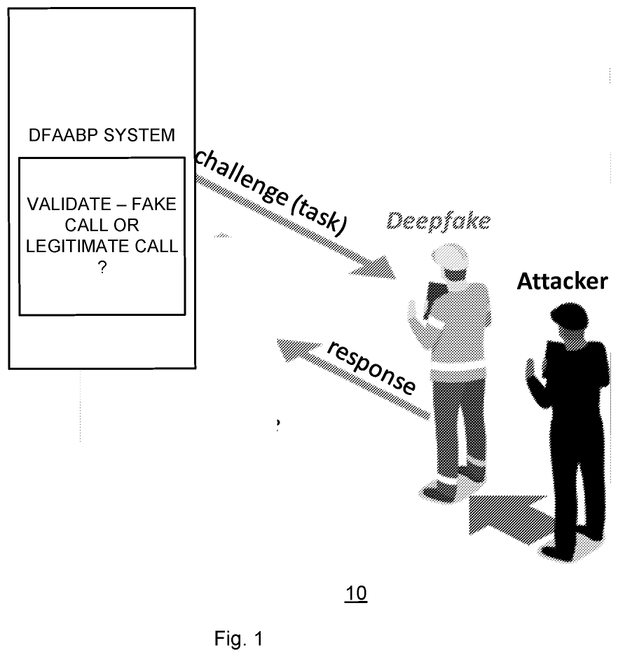

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

A computerized system is a system that includes computational resources and memory resources and is configured to execute instructions. The computational resources may include one or more processing circuits. A processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The memory resources may include one or more memory units and/or one or more memory banks and/or registers and the like. The computerized system may include one or more integrated circuits and/or one or more systems on chip and/or one or more printed circuits boards, and the like.

Any reference to a constraint or to a fulfillment of a constraint may be applied mutatis mutandis to a test. Any reference to a test may be applied mutatis mutandis to a constraint or to a fulfillment of a constraint.

Any reference to a model should be applied mutatis mutandis to a machine learning process and/or should be applied mutatis mutandis to an artificial intelligence (AI). Any reference to a machine learning process should be applied mutatis mutandis to a model and/or and should be applied mutatis mutandis to AI.

Any reference to a deep fake algorithm should be applied mutatis mutandis to a deep fake AI. Any reference to a deep fake AI should be applied mutatis mutandis to a deep fake algorithm.

The term real time may refer to a period that may be less than 0.1, 0.2, 0.5, 0.9, 1 seconds, and the like. Additionally of alternatively—the term real time may refer to a delay period (between a provision of a challenge to a start of a response to the challenge) that is lower than a period required to generate a deep fake response to a task.

### Deep Fake Algorithm Anomality Based Protection (DFAABP)

There is provided DFAABP-a system for detecting deepfake calls through task response analysis. Instead of passively observing call content, the DFAABP system actively interact with the caller by requesting that he or she to perform a task. The task is easy for a human to perform but extremely hard for a deepfake model to recreate due to limitations in attack practicality and technology. When a deepfake tries to perform the task, the resulting content (the response) will be severely distorted-making it easier for an anomality detector, classifier, or even the victim to detect.

In addition, the DFAABP may perform various tests such as an identity test, a time of response test, a realism test and a task fulfillment test. At least some of the tests may be applied by a machine learning process. An identity model and a task detection model may be used to mitigate evasion tactics. The identity model may compares the identity of the caller before and during the response to the task to ensure that the caller cannot turn off the RT-DF during the task or splice in content from other identities. Similarly, the task detection model ensures that the caller has indeed performed the task as opposed to doing nothing.

Existing CAPTCHA systems, such as reCAPTCHA challenge a deep fake AI to interpret content. In contrast, the DFAABP involves challenging a deep fake AI to create content, with additional constraints on realism, identity, task (complexity), and time.

The current application provides examples related to audio-based RT-DF attacks (voice cloning). Audio RT-DFs may be considered a more significant threat over video RT-DFs because it is easier for an attacker to make a phone call than setup a video call with the victim. Also, their occurrences in the wild are increasing. Therefore, RT-DF audio calls are arguably a bigger threat at this time. However, it is noted that the same DFAABP system proposed in this paper can be applied to video calls as well.

During an evaluation, the inventors collected five state-of-the-art audio RT-DF technologies. They performed a panel survey to see what the public thinks about their quality and the inventors evaluated the top two models on our defense and on others as well. They found that the DFAABP method can significantly enhance the performance of state-of-the-art audio-based deepfake detectors.

There is provided the first active defense against RT-DFs. Compared to existing artifact-base methods, the DFAABP (1) provides stronger guarantees of detection than using only passive detection and (2) has better longevity because the tasks are extensible.

A response to the task was tested by applying multiple tests/constraints. The multiple tests may be executed without human assistance or with human assistance.

This application includes examples related to mitigating the threat of real-time voice cloning. Furthermore, the example may be related to methods that perform speech-to-speech voice conversion (VC) as opposed to text-to-speech (TTS) methods.

Figure illustrates an example of a fake call defense scenario 10. A potential attacker may user a deepfake algorithm. A DFAABP system requests the potential attacker to respond to a task, received a response and determine whether the call of a legitimate call or a fake call.

The popular reCAPTCHA prevents bots from performing automated activities on the web by challenging the client to perform decoding distorted letters which is hard for software but easy for humans.

In contrast, deep-fake algorithm anomality triggering (DFAAT) tasks require the client to create content with at least some of the following constraints:
a. Realism (R): The content should be realistic to a human or a machine learning model.
b. Identity (I): The content should reflect the identity t.
c. Task completion (C): The content should perform an arbitrary task which is hard to generate.
d. Time (T): The content (response) should be generated in real-time.

Creating a response to this task where V (r_c)=pass is hard for existing RT-DF technologies but easy for humans. In our system the ‘hardness’ of the task directly relates to the limitations of existing RT-DF technology. The DFAABP system can be easily extended to new limitations of RT-DFs over time. This gives the DFAABP system flexibility to defend against future threats.

### Creating a Task

A task demonstrates whether a caller can or cannot create content with realism, identity, task and time constraints. Realism constraints are necessary to ensure there are no latent or semantic anomalies in the response. Identity constraints are needed to ensure that the attacker isn't just recording him/herself during the task. Task constraints are required to ensure that the deepfake model tries to operate outside the bounds of its abilities. Finally, Time constraints are involved to guarantee that the caller is using an RT-DF model since (1) the DFAABP should prevent the caller to switch to an offline model and (2) real-time models are more limited since they can only process frames and not entire audio clips.

The task to be executed by the caller may be selected out of multiple challenges associated with the task.

Let T denote a specific task, such that T=hum might be “hum a specific song.” The DFAABP system defines the set of all possible challenges for task T as C_T. The set of all possible challenges may include humming different songs.

For example, C_hum would be all possible requests for different songs to be hummed. To select a challenge to be provide to the caller as a task, (1) random seeds z_0, z_1 are generated, (2) z_0 is used to select a random task T and (3) z_1 is used to select a random challenge c \in C_T.

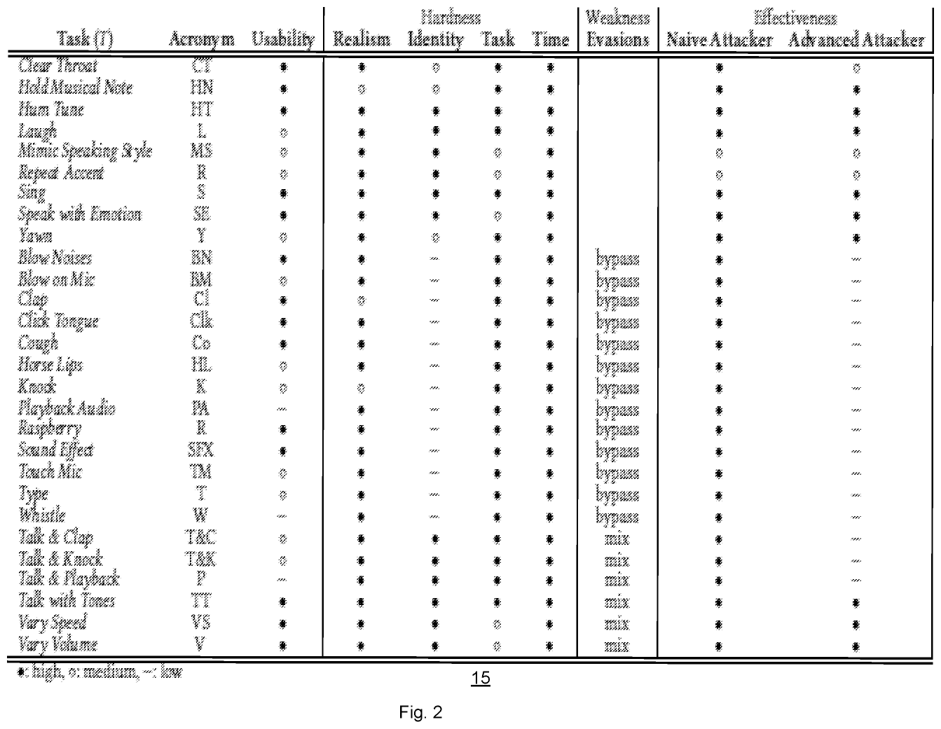

FIG. 2 includes a first table 15 that illustrates examples of tasks which can be used in DFAABP challenges. In the table, it is assumed that the RT-DF under test has been trained to have the best performance on one task—for example—regular talking.

Using observations over five state-of-the-art RT-DF models the inventors assessed the hardness, weakness, and effectiveness of each task as a challenge for details on these five models). Hardness expresses the difficulty of a modern RT-DF in successfully creating a deepfake of t given the respective constraints. Weakness states how an adversary can evade detection if the respective task is chosen. For instance, bypass is where the RT-DF is turned off and the attacker speaks directly to our system. The other case is mix is where the attacker can mix other audio sources into a_g. For example, to evade ‘talk \& clap’ the attacker creates a′_g=a_g+a_clap where a_clap is taken from another microphone so as not to disrupt the RT-DF (i.e., execute f_t(a_s+a_m)).

Effectiveness indicates how effective the challenge is given two levels of attackers: naive and advanced.

A naive attacker is one which (1) will use existing datasets and only a limited number of samples of t to train f_t and (2) forwards all audio through f_t (e.g., if a library is used as-is from GitHub).

An advanced attacker is one which will collect a practical number of samples on t (e.g., 20 minutes) and is able to mix other audio sources into a_g.

Overall, a strong challenge is a random c drawn from a random T which is hard for the adversary to perform given all four constraints.

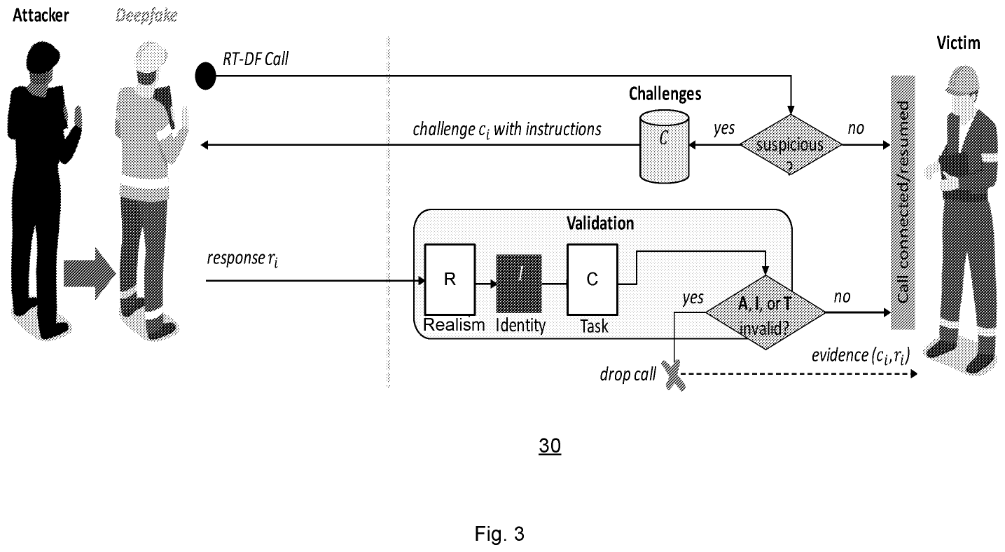

FIG. 3 is an example a DFAABP system 30 and int environment.
a. Calls are forwarded to the system using a blacklist, whitelist, policy or the victim's intuition, or any other criteria for detecting that the call is suspected or should be evaluates for any other reason
b. A deep-fake algorithm anomality triggering (DFAAT) task is generated and send to the caller.
c. The response (or lack of response) from the caller r_c is verified against the three constraints (realism, identity, task) and if all four constraints are fulfilled then the call is connected/resumed. Otherwise, the call is dropped and evidence is provided to the victim.

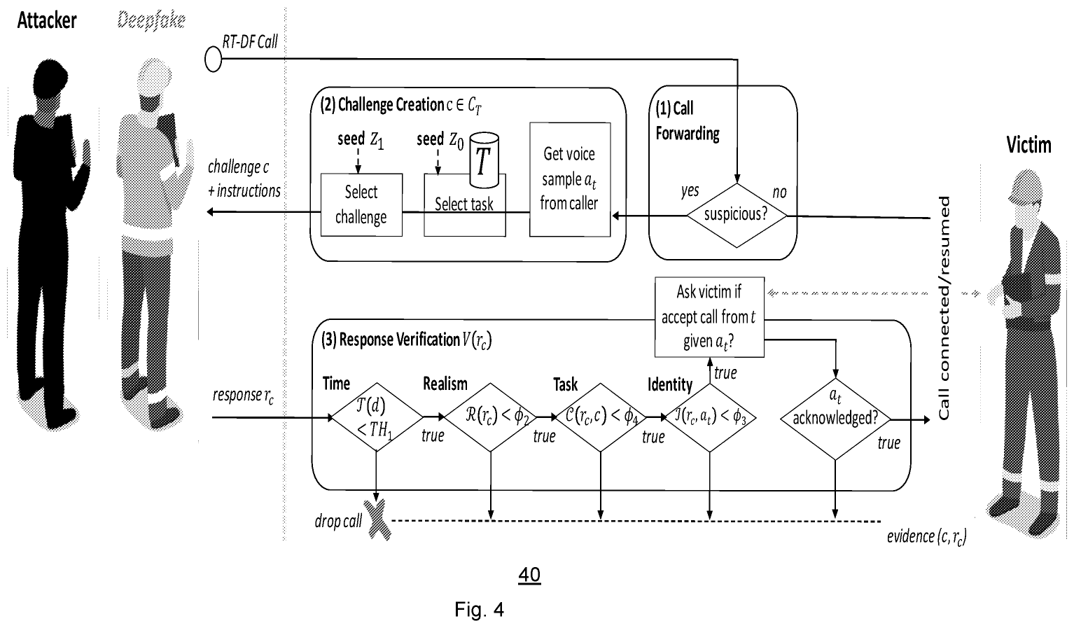

FIG. 4 is an example a DFAABP system 40 and its environment.
a. Calls are forwarded to the system using a blacklist, whitelist, policy or the victim's intuition, or any other criteria for detecting that the call is suspected or should be evaluates for any other reason.
b. A DFAAT task is generated and send to the caller.
c. The response (or lack of response) from the caller r_c is verified against the three constraints (realism, identity, task and time) and if all four constraints are fulfilled then the call is connected/resumed. Otherwise, the call is dropped and evidence is provided to the victim. Other rules regarding the four constraints may be provided.

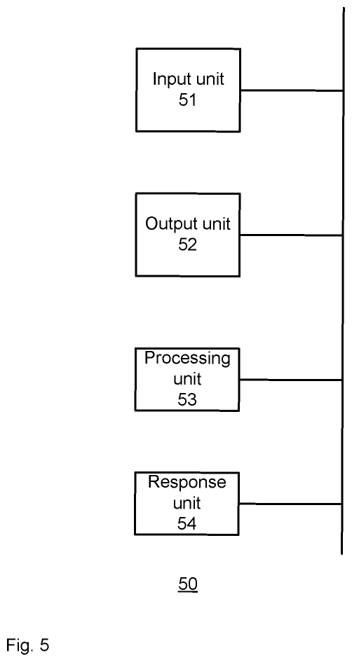

FIG. 5 illustrates an example of a DFAABP system 50.

DFAABP system 50 may be configured to execute at least one of methods 100, 101 and/or 102.

DFAABP system 50 includes:
a. Input unit 51 that is configured to receive a call from a caller.
b. Output unit 52 that is configured to request the caller to execute a deep-fake algorithm anomality triggering (DFAAT) task.
c. Processing unit 53 that is configured to determine, based on a caller related response that is received by the input unit, whether the call is a legitimate call or a fake call; wherein the determining comprises searching for one or more deep-fake algorithm anomalies associated with the DFAAT task.
d. Response unit 54 that is configured to: perform a fake call response when determining that the call is a fake call; and perform a legitimate call response when determining that the call is a legitimate call.

The input unit and the output unit may be included in a input out unit (IP) unit or may be separated from each other. The input unit and/or the output unit may include any port, communication controller, terminal, buses, switches, may include a man machine interface (MMI), and the like.

The processing unit 53 may include one or more processing circuits.

The response unit 54 may include any communication element, may be implemented at least in part by the input and/or output units, may include a man machine interface, and the like.

It should be noted than of the determination of the whether the call is a legitimate call or a fake call is requested from another entity then the DFAABP system 50 may receive to response and the response unit 54 may be configured to respond to the determination.

The DFAABP system 50 may perform a part of the determination while another part of the determination is executed by another entity.

### Verifying a Challenge

To determine whether V(r_c)=pass or fail, it should be verified whether r_c adheres to the realism, identity, Task, and time constraints. All four constraints can be verified by a human (a moderator or the victim him/herself). For example, if c=“say ‘I'm hungry’ with anger” but (1) the audio sounds strange/distorted, (2) the voice does not sound like t, (3) the task is not completed, or (4) it takes too long for the caller to respond, then this would raise suspicion. However, many users may not trust themselves enough or they may give in to social pretexts and ignore the signs—to avoid rejecting a peer. Therefore, there is provided an automated way to verify each constraint without prior knowledge of t.

Realism Verification (R). This is responsible for identify whether the content is deepfake generated. When the DF caller performs the task either (1) content will break or (2) content will not capture the task. If it breaks, the DFAABP system can detect it using an anomality detector.

If an RT-DF attempts to perform c then r_c will likely contain distortions and artifacts. This is because (1) the RT-DF is operating outside of its capabilities or (2) because the caller simply is using a poor-quality RT-DF. These distortions will make it easier for existing anomality detectors and existing deepfake classifiers to identify the RT-DF. The output of R is a score on the range [0,infinity] or [0,1] indicating how unrealistic the content of r_c is.

Identity Verification (I). This is responsible for verifying that the identity of the caller has not changed since the start of the call. Important to prevent the attacker from simply switching to his normal voice to perform the task or from performing a replay attack. To determine if r_c has the identity t, the DFAABP system can do as follows: (1) collect a short audio sample a_t of the caller prior to the challenge and have the victim acknowledge the identity, and (2) use zero-shot voice recognition model to verify that the identity in a_t and r_c are the same. The reason the inventors have the victim acknowledged t in a_t is to prevent the attacker from switching the identity after the challenge. Alternatively, interaction with the victim can be avoided if continuous voice verification is used on the caller. However, doing so would be expensive. The output of I is a similarity score between a_t and r_c.

Task Verification (C). This is responsible for verifying that the task was performed. This is to prevent attacker from ‘doing nothing’ or another task-so no anomality appears. It also helps catch the case where the DF fails by not producing the task (which has no media anomalies). There are two cases where r_c would not contain the requested task: (1) the model failed to generate the content and (2) the attacker is trying to evade generating artifacts by performing another task or nothing at all. To ensure that r_c contains the task, the DFAABP system can use a machine learning classifier. The output of C is the probability that r_c does not contain the task.

Time Verification (T). The time constraint can be verified by ensuring that the first frame of r_c is received within roughly 1 second after of the challenge's start time (i.e., after the instructions for c are given). The output of T is the measured time delay denoted d.

Altogether, the DFAABP system may validate r_c if none of the four algorithms (T,R,I,C) exceed their respective thresholds (TH_1,TH_2,TH_3,TH_4) where each threshold has been tuned accordingly. The DFAABP system may invalidate r_c if any model exceeds its respective threshold. The false reject rate can be tuned by weighing the contribution of each constraint, however doing so will compromise the security of the system.

In summary, validation is performed as follows:

$$V ( r\_c ) = PASS when T ( d ) < TH\_ 1 , R ( r\_c ) < TH\_ 2 , and$$

$$I ( r\_c , a\_t ) < TH\_ 3 , C ( r\_c , c ) < ∖ TH\_ 4.$$

$$ELSE - FAIL$$

It is noted that a combination of validation methods for each constraint can be used to increase performance, security and usability. For example, some verifications can be done with humans, some with algorithms and some with both.

### Detection Framework

A DFAABP framework is presented which can be used to protect users (victims) from fake callers. A summary of the DFAABP framework can be found in FIG. 2.

### Call Forwarding

The very first step is to decide which calls should be forwarded to the system. In high risk settings, a DFAABP may be used to verify every caller. However, this is not practical in most settings. Instead, calls can be forwarded to the system using blacklists (e.g., known offenders) or policies. An example policy is to forward all callers who are not in the victim's address book, or to screen all calls during working hours.

Alternatively, call screening can be activated by the user. For example, if a call arrives from an unknown number, the user can choose to forward it to the DFAABP system if the call is unexpected. Another option is to let users forward ongoing calls if (1) the caller's audio sounds strange, (2) the conversation is suspicious, or (3) a sensitive discussion needs to be made. For example, consider the scenario where a user receives a call from a friend under an odd pretext such as “I'm stuck in Brazil and need money to get out.” Here, the user can increase his/her confidence in the caller's authenticity after forwarding the call through the DFAABP system.

### Challenge Creation

A random challenge c is generated using the approach described in section verify. In addition to c, instructions for the caller are generated. Instructions include a list of actions to perform and a start indicator. For example, an instruction might be “at the tone, knock three times while introducing yourself.” The instruction is then converted into an audio message using TTS.

At the start of the challenge, the caller is asked to state his/her name. This recording is saved as a_t and shared with the victim for acknowledgment and with I for identity verification. Next, the audio instructions are played to the caller. After playing the instructions, a tone is sounded. The time between the tone and the first audible sounds from the caller is measured and included as part of r_c for T. After a set number of seconds, the caller's recording is saved as r_c and passed along for verification.

### Response Verification

The recorded response r_c and its timing data are sent to T, R, C, and I for constraint verification. If all the algorithms yield scores below their respective thresholds, then a_t is played to the user. If the user accepts the call with t then the DFAABP is valid and the call is connected/resumed.

If any of the algorithms produce a score above their threshold, then the call is dropped, and evidence is provided to the user. Evidence consists of an explanation of why the call was not trusted (e.g., information on which constraint(s) failed and to what degree) and playback recordings of a_t, c, and r_c accordingly. Although the order which the models are executed does not matter, the DFAABP system can avoid executing redundant models if one model detects the deepfake. Therefore, it is suggested to check the constraints in the order T→R→C→I to potentially save execution time when detecting a deepfake. If higher security is required, then multiple DFAABPs can be sent out and subsequently verified to reduce the false negative rate.

### Deployment

In general, the framework can be deployed as an app on the victim's phone or as a service in the cloud. For example, onsite technicians, bankers, and the elderly can have the system screen calls directly on their phones. Call centers and online meeting rooms can use cloud resources to screen callers in waiting rooms (e.g., before connecting to a confidential Zoom meeting).

The system should be capable of interacting with the deepfake so it can only protect against RT-DFs.

As the system required a caller to perform one or more challenge—the burden imposed on the caller should be set to provide a desired tradeoff of being able to detect fake calls and without being a hindrance to users if not tuned correctly. Regardless, it's a great solution for screening callers entering high security conversations and meetings in an age where calls cannot be trusted.

Finally, the system uses deep learning models in R, I, and C. Just like other deep learning-based defenses, an attacker can potentially evade these models using adversarial examples. However, when trying to evade our system, the attacker must overcome a number of challenges: (1) most calls are made over noisy and compressed channels reducing the impact of the perturbations, (2) performing this attack would require real-time generation of adversarial examples, and (3)R, I, and C would most likely be a black box to the attacker, although not impervious, it cannot be easily queried. Furthermore-R and/or I and/or C may be updated overtime and/or may be changed over time and thus may continue to be unpredictable and/or continue to track new deepfake algorithms.

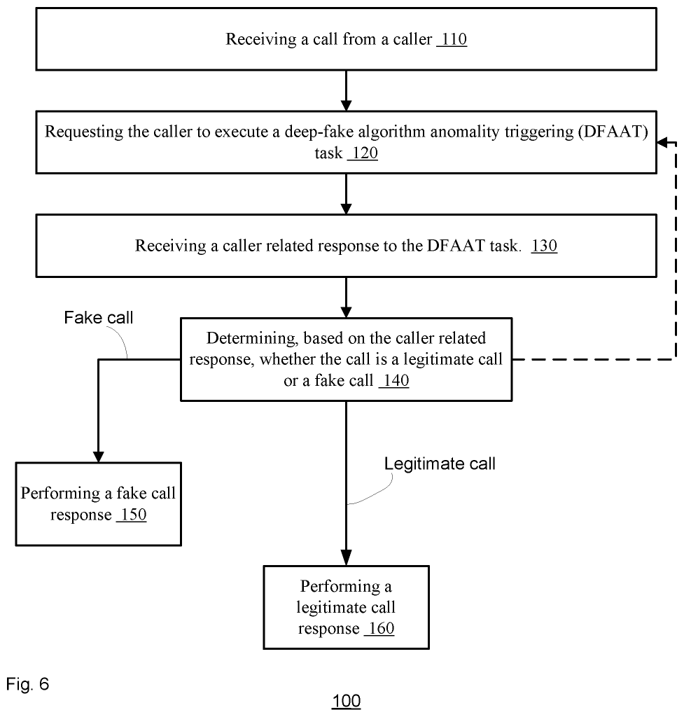

FIG. 6 illustrates an example of method 100 for preventing fake calls.

Method 100 may start by step 110 of receiving a call from a caller.

Step 120 may be followed by requesting the caller to execute a deep-fake algorithm anomality triggering (DFAAT) task. The DFAAT task can be selected out of multiple challenges.

The DFAAT task may be determined in various manners—for example may be determined based on analysis and/or learning of existing deep fake algorithms, estimating future and/or unknown deep fake algorithms and the like. The determination of the DFAAT challenge may be executed continuously, on a non-continuous manner, and the like.

A DFAAT task can be selected out of many challenges associated with the task. There also may be different tasks.

Many DFAAT tasks and/or many DFAAT challenges may be used to detect a response generated by one or more deep fake algorithms. Using a large number of DFAAT challenges to test a single deep fake algorithm may reduce the chance that the deep fake algorithm will have a predefined response to the each one of the challenges and may statistically increase the likelihood of making a correct decision.

Step 120 may include selecting the DFAAT task and/or selecting a DFAAT challenge associated with the task.

Step 120 may be followed by step 130 of receiving a caller related response to the DFAAT task.

The caller related response may include an attempt to execute the challenge or may be a lack of an attempt of executing the challenge.

Step 130 may be followed by step 140 of determining, based on the caller related response, whether the call is a legitimate call or a fake call.

A deep-fake algorithm anomality associated with the DFAAT challenge may be an anomality that is known to be generated by a deep-fake algorithm.

A deep-fake algorithm anomality associated with the DFAAT challenge may be an anomality that is not known to be generated by a deep-fake algorithm—but may be suspected or estimated to be generated by a deep-fake algorithm. For example—if it is known that legitimate calls made to a certain victim exhibit a certain kind of noise-then receiving a call from an unknown person that exhibits the certain kind of noise may not be indicative that the call is a fake call.

The determining includes searching for one or more deep-fake algorithm anomalies associated with the DFAAT challenge. When one or more properties of the deep-fake algorithm anomalies are known—for example timing of the deep-fake algorithm anomalies and/or which act or text of phenomes is expected to involve an artifact—the searching may be based on the properties. For example—the anomalies are searches at specific timings and/or following various events. This may include ignoring irrelevant portions of the challenges-which may save resources.

Step 140 may include checking a fulfillment of one or more constraints-thus the response should comply with one or more constraints.

Examples of constraints include a realism constraint (also referred to “R” or “realism”), an identity constraints (also referred to as “I” or “identity”), a task constraint (also referred to as “C” or “Task”), and a time constraint (also referred to as “T” or “time”).

Step 140 may include checking the fulfillment of R and/or the fulfillment of I and/or the fulfillment of C and/or the fulfillment of T.

Any rule may be applied on the outcome of each evaluated constraint to determine of whether a call is a fake call or a legitimate call. For example—a call is a fake call if any of the evaluated constraints fails. Another example may include a more tolerant test.

It should be noted that while various examples of the application illustrate a hard decision per constraint (fulfilled or not fulfilled)—then another example may use a soft decision or any other decision that can provide a non-binary outcome regarding to the fulfillment of the constraint. In this case the rule may be used which takes into account the non-binary results of one or more constraints fulfillment tests.

The checking of the fulfillment of the realism constraint may be executed without using previously recorded audio or video. Thus-if may not depend on prior registration of the caller or obtaining access to a previous recording or audio and/or video from the caller.

The fulfillment of the realism constraint may be evaluated by a realism constraint machine learning process.

The fulfillment of the identity constraint may be evaluated by an identity constraint machine learning process.

The fulfillment of the identity constraint may include comparing between (i) an identity of the caller before starting the challenge, to (ii) an identity of the caller during the caller related response.

Step 140 may include sequentially determining a fulfillment of constraints, stopping the sequentially determining and declaring the call to be a fake call upon a first non-fulfillment of one of the constraints.

Step 140 may include performing additional and/or other determinations-such as determining to repeat steps 120-140—and to jump to step 120.

Step 140 may include determining to jump to step 120 for various reasons—for example—when finding that the call is suspected to be a fake call—but there is a need to perform at least one other task to determine whether the call is a fake call. Yet another reason for jumping to step 120—there may be a need to provide another DFAAT task in order to induce other artifacts and/or in order to better test other deep fake algorithms. It should be noted that at least two different DFAAT tasks (of at least two different iterations) may be tailored to trigger one or more anomalies of different deep-fake algorithms.

When multiple iterations of steps 120-130 are executed—the determining (of step 140) of whether the call is a fake call or a legitimate call may be based on the results of the multiple results or on the results of one or some of the multiple results.

The determining of step 140 may include checking the fulfillment of one or more constraints.

In this case step 140 is followed by step 120. In this case step 120 may include selecting the same DFAAT task or selecting another DFAAT task. The selection of a task may be followed by selecting a challenge out of multiple challenges associated with the task.

When determining that the call is a fake call-step 140 is followed by step 150 of performing a fake call response. Examples of a fake call response include terminating the call, alerting the target of the call of any other entity such as the police, a cyber enforcement entity, a cyber analysis entity, marking the caller as a fake call source, and the like.

When determining that the call is a legitimate call-step 140 is followed by step 160 of performing a legitimate call response. Examples of a fake call response include enabling a reception of the call by an intended recipient of the call—for example relaying the call to the intended recipient.

The DFAAT tasks and/or the DFAAT challenges may be dynamically updates. Non-limiting example of DFAAT tasks and/or of DFAAT challenges that were proved to be effective against some existing deep fake algorithms may include clearing a throat of the caller, humming a tune defined in the DFAAT task, laughing, singing a song defined in the DFAAT task, turning around in a manner defined in the DFAAT task, interacting with an object in a manner defined in the DFAAT task, contacting a body part in a manner defined in the DFAAT task, dropping and/or picking up an object defined by the DFAAT task—may also be in a manner defined by the DFAAT task, bouncing an object defined by the DFAAT task—may also be in a manner defined by the DFAAT task, folding a shirt in a manner defined by the DFAAT task, interact with background scenery in a manner defined by the DFAAT task, stroke hair in a manner defined by the DFAAT task, spill water or fluid in a manner defined by the DFAAT task, repeat accent in a manner defined by the DFAAT task, change tone of speech and/or speed of speech in a manner defined by the DFAAT task, whistle in a manner defined by the DFAAT task.

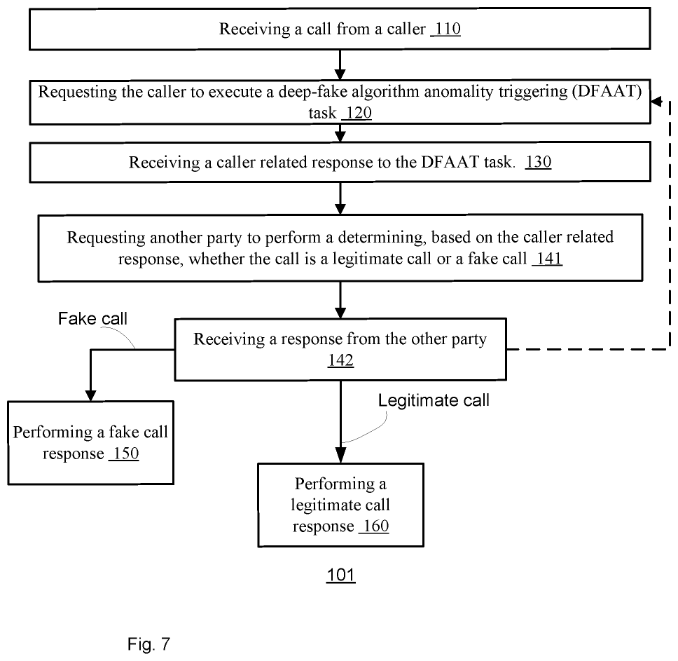

FIG. 7 illustrates an example of method 101 for preventing fake calls.

Method 101 may start by step 110 of receiving a call from a caller.

Step 110 may be followed by step 120 of requesting the caller to execute a deep-fake algorithm anomality triggering (DFAAT) task. The DFAAT task can be selected out of multiple challenges.

The DFAAT task may be determined in various manners—for example may be determined based on analysis and/or learning of existing deep fake algorithms, estimating future and/or unknown deep fake algorithms and the like. The determination of the DFAAT challenge may be executed continuously, on a non-continuous manner, and the like.

A DFAAT task can be selected out of many challenges associated with the task. There also may be different tasks.

Many DFAAT tasks and/or many DFAAT challenges may be used to detect a response generated by one or more deep fake algorithms. Using a large number of DFAAT challenges to test a single deep fake algorithm may reduce the chance that the deep fake algorithm will have a predefined response to each one of the challenges.

Step 120 may include selecting the DFAAT task and/or selecting a DFAAT challenge associated with the task.

Step 120 may be followed by step 130 of receiving a caller related response to the DFAAT task.

The caller related response may include an attempt to execute the challenge or may be a lack of an attempt of executing the challenge.

Step 130 may be followed by step 141 of requesting another party (for example another computerized system or a human) to perform a determining, based on the caller related response, whether the call is a legitimate call or a fake call.

Step 141 may be followed by step 142 of receiving a response from the other party.

When it is determined that the call is a fake call-step 142 is followed by step 150 of performing a fake call response. Examples of a fake call response include terminating the call, alerting the target of the call of any other entity such as the police, a cyber enforcement entity, a cyber analysis entity, marking the caller as a fake call source, and the like.

When it determined that the call is a legitimate call-step 142 is followed by step 160 of performing a legitimate call response. Examples of a fake call response include enabling a reception of the call by an intended recipient of the call—for example relaying the call to the intended recipient.

As in method 100—multiple repetitions of steps 120 and 20 may be executed.

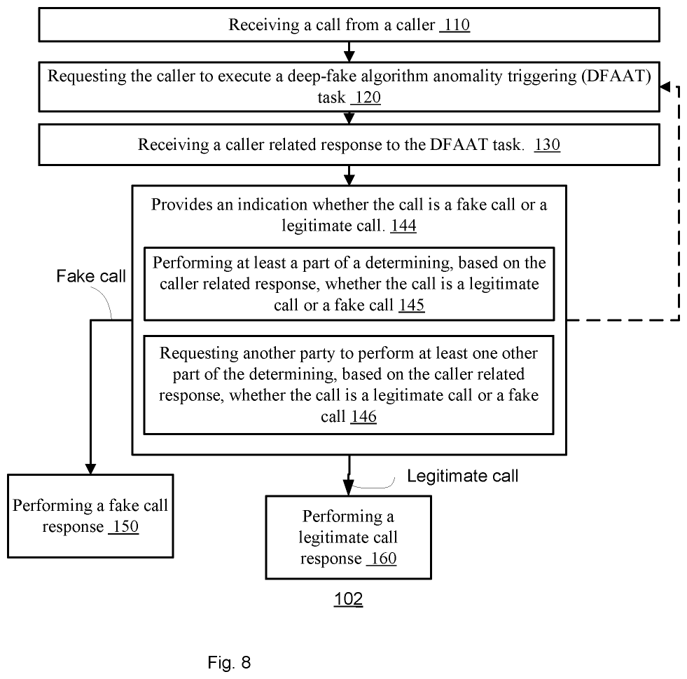

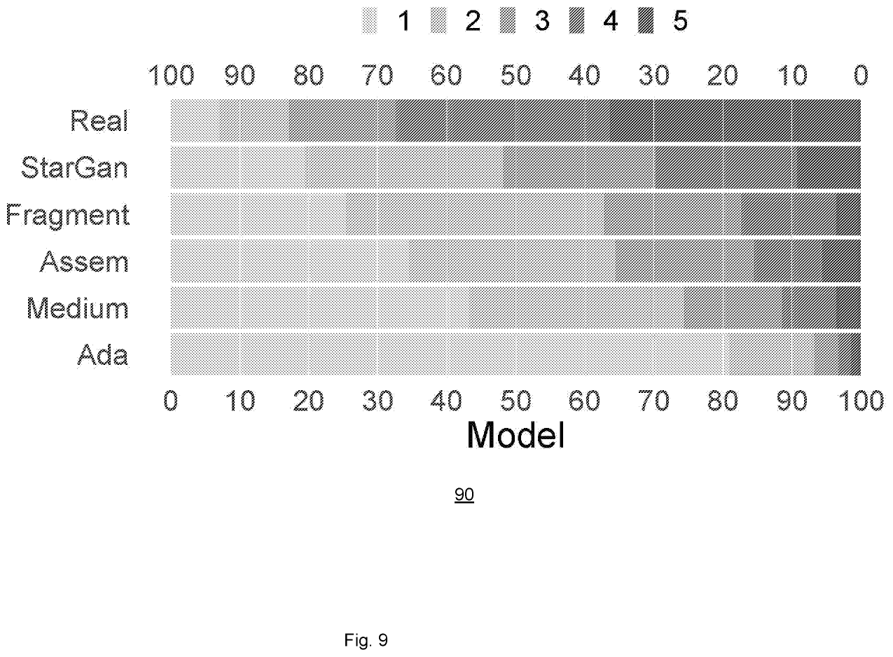

FIG. 8 illustrates an example of method 102 for preventing fake calls.

Method 102 may start by step 110 of receiving a call from a caller.

Step 110 may be followed by step 120 of requesting the caller to execute a deep-fake algorithm anomality triggering (DFAAT) task. The DFAAT task can be selected out of multiple challenges.

The DFAAT task may be determined in various manners—for example may be determined based on analysis and/or learning of existing deep fake algorithms, estimating future and/or unknown deep fake algorithms and the like. The determination of the DFAAT challenge may be executed continuously, on a non-continuous manner, and the like.

A DFAAT task can be selected out of many challenges associated with the task. There also may be different tasks.

Many DFAAT tasks and/or many DFAAT challenges may be used to detect a response generated by one or more deep fake algorithms. Using a large number of DFAAT challenges to test a single deep fake algorithm may reduce the change that the deep fake algorithm will have a predefined response to the each one of the challenges.

Step 120 may include selecting the DFAAT task and/or selecting a DFAAT challenge associated with the task.

Step 120 may be followed by step 130 of receiving a caller related response to the DFAAT task.

The caller related response may include an attempt to execute the challenge or may be a lack of an attempt of executing the challenge.

Step 130 may be followed by step 144. Step 144 may include steps 145 and step 146. Step 144 provides an indication whether the call is a fake call or a legitimate call.

Step 145 may include performing at least a part of a determining, based on the caller related response, whether the call is a legitimate call or a fake call.

Step 146 may include requesting another party (for example another computerized system or a human) to perform at least one other part of the determining, based on the caller related response, whether the call is a legitimate call or a fake call.

Steps 145 and 146 may be executed independently from each other. Alternatively, step 145 may provide information to step 146 and step 146 may be responsive to the information- and/or step 146 may provide information to step 145 and step 145 may be responsive to the information.

A part of the determining may include evaluating a fulfilment of one or more constraint. Yet for another example—a part of the determining may include obtaining results of fulfillment of constraints and determining the type of the call (fake or legitimate) based on the results.

There may be more than one iteration of steps 145 and 146 within step 144.

Step 144 may include performing additional and/or other determinations-such as determining to repeat steps 120-144—and to jump to step 120.

Any reference to step 140 may be applied mutatis mutandis to step 144—especially given who is executing a part of the determining.

When it is determined that the call is a fake call-step 144 is followed by step 150 of performing a fake call response. Examples of a fake call response include terminating the call, alerting the target of the call of any other entity such as the police, a cyber enforcement entity, a cyber analysis entity, marking the caller as a fake call source, and the like.

When it determined that the call is a legitimate call-step 144 is followed by step 160 of performing a legitimate call response. Examples of a fake call response include enabling a reception of the call by an intended recipient of the call—for example relaying the call to the intended recipient.

As in method 100—multiple repetitions of steps 120 and 20 may be executed multiple times.

### Appendix-A—Teats and Analysis

There is provided an analysis of a threat posed by RT-DFs by evaluating the quality of five state-of-the-art RT-DF models in the perspective of 41 volunteers.

### Experiment Setup

### RT-DF Models

The inventors surveyed 25 voice cloning papers published over the last three years which can process audio in real-time as a sequence of frames. Of the 25 papers the inventors selected the four recent works which published their source code: AdaIN-VC, Medium VC, FragmentVC and StarGANv2-VC. The inventors also selected ASSEM-VC which is a non-casual model as an additional comparison. All works are from 2021 except AdaIN-VC which is from 2019.

StarGANv2-VC is many-to-many model which also works as an any-to-many model. The audio a_g is created by passing the spectrogram of a_s through an encoder-decoder network. To disentangle content from identity, the decoder also receives an encoding of a_s taken from a pretrained network which extracts the fundamental frequencies. Finally, the decoder receives reference information on t via a style encoder using sample a_t. ASSEM-VC works in a similar manner except a_s and a TTS transcript of a_s are used to generate a speaker independent representation before being passed to the decoder, and the decoder receives reference information on t from an identify encoder.

AdaIN-VC, a_g is created by disentangling identity from content. The model (1) passes a sample a_t through an identity encoder, (2) passes a source frame a_s (i) through a content encoder with instance-normalization, and then (3) passes both outputs through a final decoder. In MediumVC, a_s first normalizes the voice by converting it to a common identity with an any-to-one VC model. The result is then encoded and passed to a decoder along with an identity encoding (similar to AdaIN-VC). FragmentVC, extracts the content of a_s using a Wav2Vec 2.0 model and extracts fragments of a_t using an encoder. A decoder then uses attention layers to fuse the identity fragments into the content to produce a_g.

All audio clips in this experiment were generated using the pre-trained models provided by the original authors. To simulate a realistic setting, the clips were passed through a phone filter (a band pass filter on the 0.3-3 KHz voice range).

### Experiments

To help quantify the threat of RT-DFs, the inventors performed two experiments on a group of 41 volunteers:
EXP1a—Quality. The goal of the first experiment was to see how easy it is to identify an RT-DF in the best-case scenario (when the victim is expecting a deepfake).
EXP1b—Identity. The goal of this experiment was to understand how well RT-DF models are able to clone identities.

In EXP1a, volunteers were asked to rate audio clips on a scale of 1-5 (1: fake, 5: real). There were 90 audio clips presented in random order: 30 real and 60 fake (12 from each of the five models). The clips were about 4-7 seconds long each.

In EXP1b, the inventors selected the top 2 models that performed the best in EXP1. For each model, the inventors repeated the following trial 8 times: The inventors first let the volunteer listen to two real samples of the target identity as a baseline. Then the inventors played two real and two fake samples in random order and asked the volunteer to rate how similar their speakers sound compared to the speaker in the baseline.

If a model has a positive mean opinion score (MOS) in both EXP1 and EXP2 then it is a considerable threat. This is because it can (1) synthesize high quality speech (2) that sounds like the target (3) all in real-time.

### Experiment Results

EXP1a. To analyze the quality (realism) of the models, the inventors compared the MOS scores of the deepfake audio to the MOS of the real audio (both scored blindly). Figure includes graph 90 that illustrates the distribution of each model's MOS compared to real audio. Roughly 20-50\% of the volunteers gave the RT-DF audio positive score with StarGANv2-VC having the highest quality.

However, opinion scores are subjective. Therefore, there is a need to normalize the MOS to count how many times volunteers were fooled by an RT-DF. In principle, the range of scores a volunteer k has given to real audio captures that volunteer's ‘trust’ range. Let mu_real_k and sigma_real_k be the mean and standard deviation on k's scores for real clips. The inventors estimated that a volunteer would likely be fooled by a clip if he or she scores a clip with a value greater than mu_real_k-sigma_real_k.

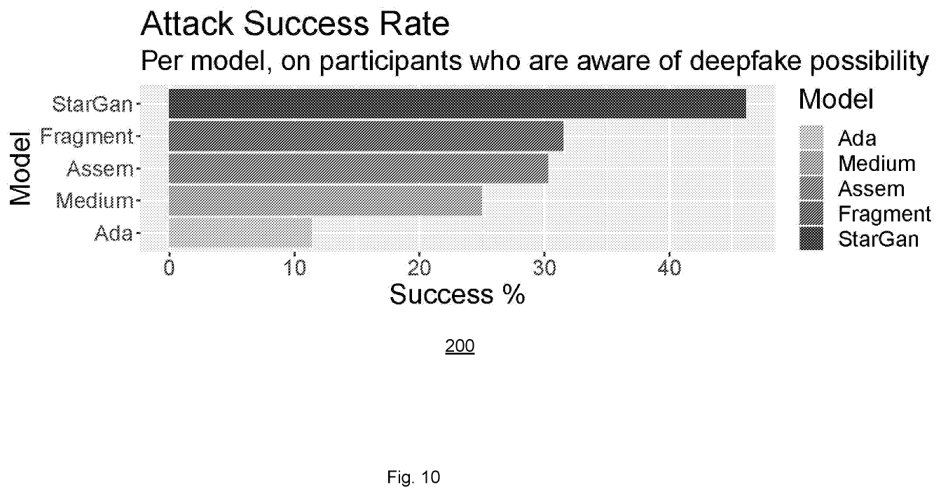

Using this measure, graph 200 of FIG. 10 presents the attack success rate for each of the RT-DF models. The inventors found that StarGANv2-VC has the highest success rate of 46\% percent rate. This means that although current RT-DF models are not perfect, they can indeed fool people. It is noted that these results cannot be interpreted as the likelihood of a true RT-DF attack succeeding. This is because our volunteers were expecting to hear deepfakes and were therefore carefully listening for artifacts. A true victim would likely overlook some artifacts especially when put under pressure by the attacker.

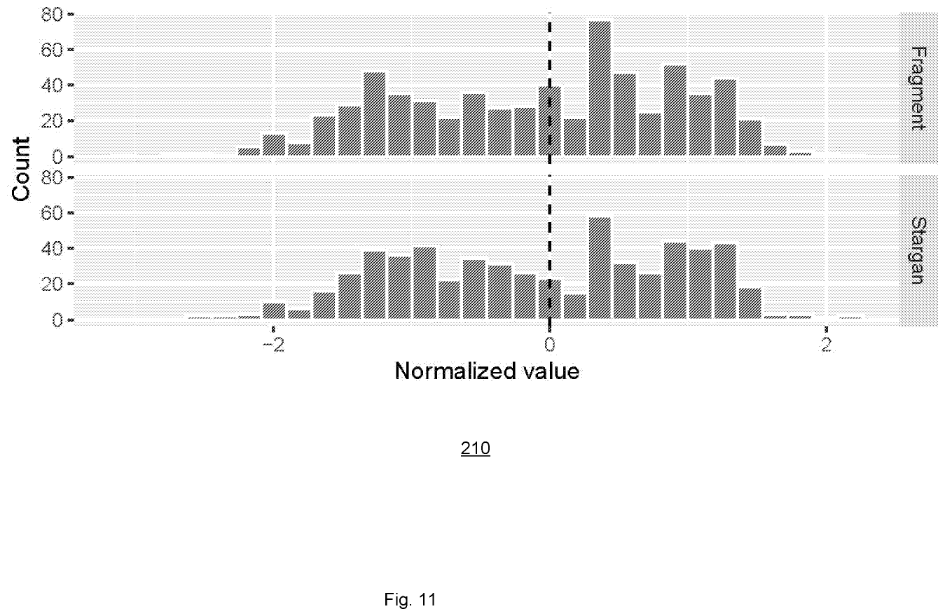

EXP1b. To analyze the ability of the models to copy identities, the inventors normalized volunteer k's scores on fake audio by computing (score-mu_real_k)/(sigma_real_k). FIG. 11 includes graph 210 that plots the distribution of the normalized scores on fake audio. the DFAABP system can see that the volunteers were mostly indecisive, rating some fake clips as more authentic and some as less. For the majority of cases (score>−1) volunteers felt that the identity was captured well by the top two models.

In summary, there is a chronological trend given that the worst performing model AdaIN-VC is from 2019 and the best StarGANv2-VC is from 2021. This may indicate that the quality of RT-DF is rapidly improving. This raises concern, especially since the volunteers were expecting the attack yet could not accurately tell which clips were real or fake. Another insight the inventors have is that the presence of artifacts can help victims identify RT-DFs. However, as quality improves, the inventors expect that only way to induce significant artifacts will be by challenging the model.

### DFAABP Evaluation

In this section, the inventors evaluate the benefit of using a DFAABP as opposed to using passive defenses alone.

### Experiment Setup

### Datasets

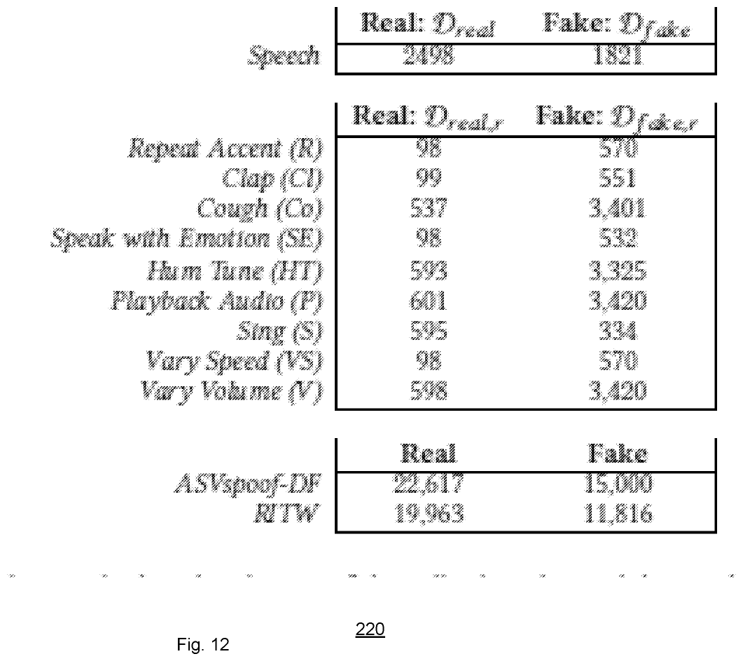

To evaluate the DFAABP system, the inventors recorded 20 English speaking volunteers to create both speech and challenge-response datasets, summarized in second table 120 of FIG. 12.

(D_real)—2498 samples of real speech (100-250 random sentences spoken by each of the 20 volunteers).

(D_fake)—1821 samples of RT-DF voice conversion. To create this dataset the inventors used StarGANv2-VC which was the top performing model from EXP1a. The model was trained to impersonate 6 of the 20 volunteers from D_real, and an additional 14 random voice actors from the VCTK dataset. The additional 14 were added to help the model generalize better, and only the 6 volunteers' voices were used to make RT-DFs.

(D_real,r)—3317 samples of real responses (attempts at challenges). A sample of nine tasks were evaluated in total. The following tasks were performed ˜30 times per volunteer: sing(S), hum tune (HT), coughing (Co), vary volume (V), and talk \& playback (P), and the following tasks were performed ˜5 times per volunteer: repeat accent (R), clap (Cl), speak with emotion (SE), and vary speed (VS).

(D_fake,r)—16,123 deepfake samples of RT-DF voice conversion applied to the responses D_real,r using StarGANv2-VC. Samples from the same identity (i.e., where s=t) were not used.

It took each volunteer over an hour to record their data. The volunteers were compensated for their time. For all train-test splits used in our evaluations, the inventors made sure not to use the same identities in both the train and test sets. The reader can listen to our real and fake audio samples online.

In addition, the inventors also used public deepfake datasets to train the realism models R. These datasets were the ASVspoof-DF dataset \citeyamagishi2021asvspoof with 22,617 real and 15,000 fake samples, and the RITW dataset does with 19,963 real and 11,816 fake samples.

### Models

Our system, when fully automated, may include 3 models: R, C and I. The algorithm T may not use a machine learning model to verify the time constraint.

For the realism model R, the inventors evaluated five different deepfake detection models: SpecRNet which is a novel neural network architecture, inspired by RawNet2, which get results comparable to state-of-the-art models despite a significant decrease in computational requirements. One-Class is a method that is based on a deep residual network ResNet-18. They improve and generalize the network performance using One-Class Softmax activations. GMM-ASVspoof is a Gaussian mixture model (GMM) which operates on LFCCs features. This model was a baseline for the in ASVspoof 2021 competition. PC-DARTS is a convolutional neural network (CNN) that tries to automatically learn the network's architecture. This work also showed good results in generalizing to unseen attacks. Finally, Local Outlier Factor (LOF) was used-which is a density-based anomality detection model.

The union of ASVspoof-DF and RITW was taken and selected 80\% at random for training the models and 10\% for validation (early stopping). The models were tested on the baseline scenario (D_real and D_fake) and our proposed DFAABP scenario (D_real,r and D_fake,r).

For the task model C, a GMM classifier was trained on the MFCC features using the baseline model from GMM-ASVspoof. One model was trained per task: to classify between real responses from that task and all other tasks as well as speech. A 70-30 train-test split was used.

For the identity model I, the inventors used a pre-trained voice recognition model from the SpeechBrain toolkit. The model uses the ECAPA-TDNN architecture to classify a speaker. If I should not have prior knowledge of t, the model was converted to an anomality detector. Recall that a voice sample a_t was obtained from the caller prior to the challenge. This sample is used as a reference to ensure that the RT-DF is not turned off during the challenge. To detect whether the identity of the caller has changed during the challenge, the following was computed: I(a_t, r_c)=(∥f*(a_t)−f*(r_s)∥)\hat{ }2

Where f* is the speaker encoding, taken from an inner layer of the speech recognition model. Smaller scores indicate similarity between the voice before the challenge and during the challenge. This technique of comparing speaker encodings has been done in the past. To evaluate I, negative pairings were created as samples from the same identity (a_i, r_c,i) and positive pairings as samples from different identities (a_i, r_c,j), where: a_i,a_j e D_real, r_c,i,r_c,j e D_real,r, and I differs from j.

### Experiments

The inventors performed four experiments:

EXP2a R: A baseline comparison between existing solutions (passive) and our solution (active) in detecting RT-DFs EXP2b C: An evaluation of the task detection model which ensures that the caller indeed performed the challenge.

EXP2c I: An evaluation of the identity model which ensures that the caller didn't just turn off the RT-DF for the challenge.

EXP2d R,C,I: An evaluation of the system end-to-end to evaluate the performance of the system as a whole.

The inventors did not evaluate T because it is just a restriction that the first frame of the response r_c be received within approximately one second from the start time of the challenge.

To measure the performance of the models, the inventors used the area under the curve (AUC) and equal error rate (EER) metrics. AUC measures the general trade-off between the true positive rate (TPR) and the false positive rate (FPR). An AUC of 1.0 indicates a perfect classifier while an AUC of 0.5 indicates random guessing. The EER captures the trade-off between the FPR and the false negate rate (FNR). A lower EER is better.

### Experiment Results

### EXP2a (R)

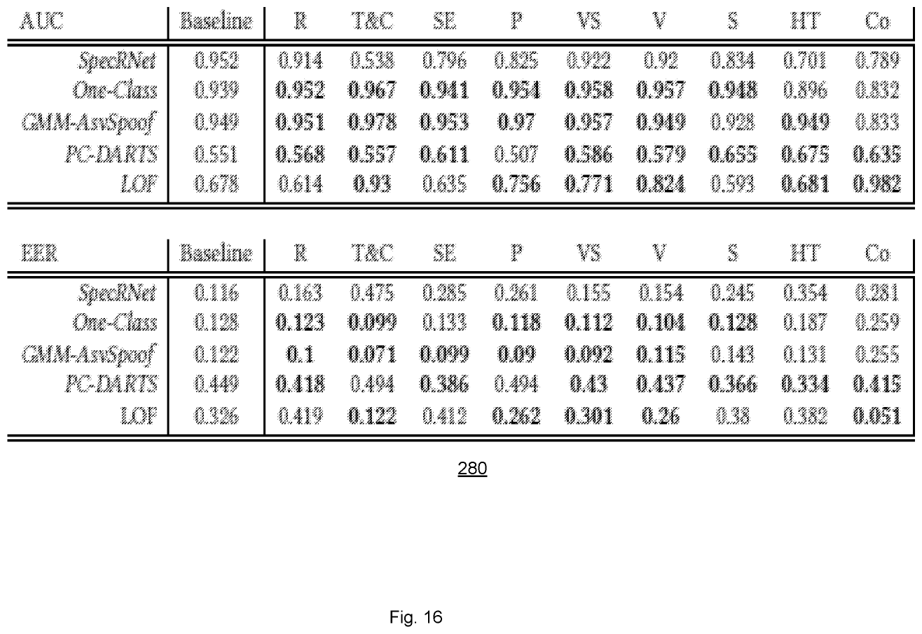

The goal of EXP2a was to see if our system can improve the detection of RT-DFs if the adversary is forced to perform a task that is outside of the deepfake model's capabilities. In a third table 280 of FIG. 16, the performance of the five deepfake detectors were compared on (1) detecting regular deepfake speech (baseline) and on (2) detecting deepfake challenges. The bold values indicate challenges which improved the performance of the corresponding model. It can be seen that with the exception of SpecRNet, all of the detectors benefit from examining challenges. Overall, the best performing model was GMM-ASVspoof with the challenges. This means that the challenges provide a better way to detect RT-DFs.

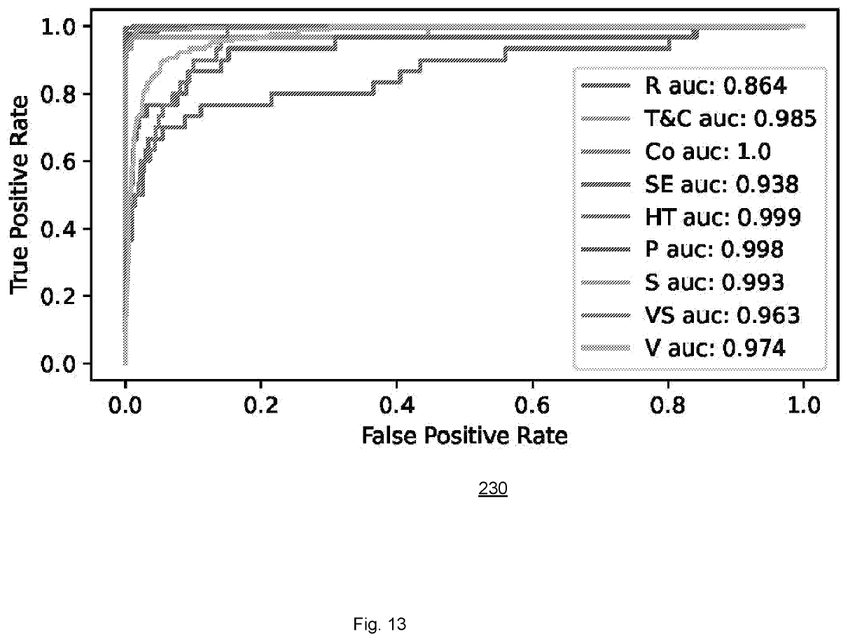

EXP2b (C). If an attacker is evasive, he may try to do nothing instead of the challenge. It's also possible that the attacker will try the challenge, but the model will output nothing because it can't generate the data. FIG. 13 (graph 230) shows that either way, the task detector C can tell whether the task was performed or not with high certainty.

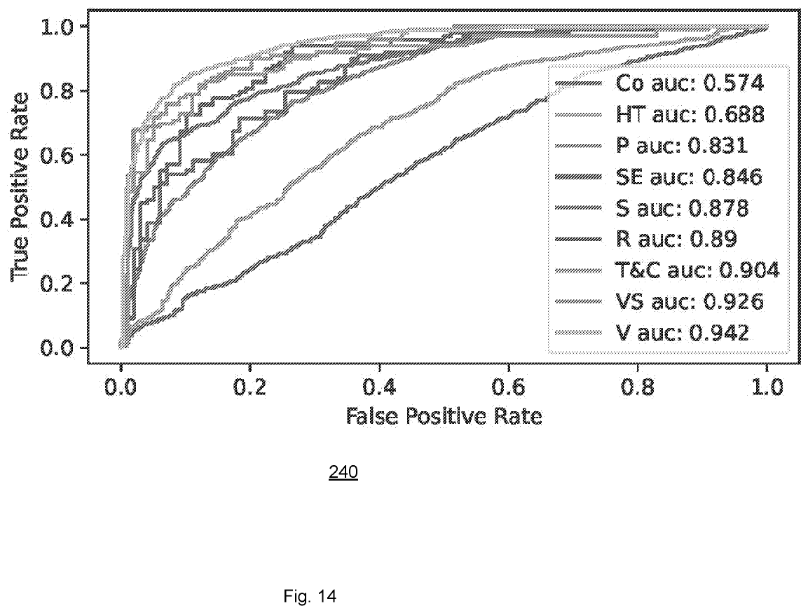

EXP2c (I). Another evasive strategy is where the attacker turns off the RT-DF while performing the challenge. In this scenario, a comparison was made between the identity of the caller before (a_t) and during (r_c) the challenge. In FIG. 14 includes graph 240 that provides results of the identity detector I. Here the DFAABP system can see that the model does quite well, with the exception of the tasks ‘hum’ and ‘cough’ which do not carry much of the speaker's identity.

### EXP2d (R,I,C): DFAABP

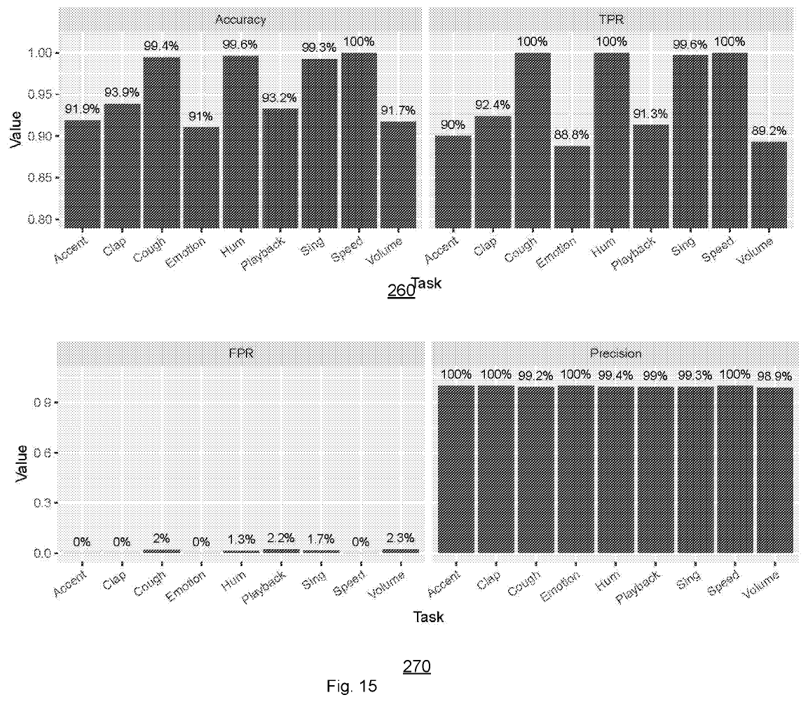

Finally, when executing all three models, it was considered how the successes and failures of each model compound together. The threshold for each model (R,I,C) was set so that the FPR=0.01. The text included passing through 3,317 real responses and 8,758 deepfake responses. FIG. 15 presents the results—260 and 270.

The inventors found that the DFAABP system was able to achieve a TPR of 0.89-1.00. FPR of 0.0-2.3 and accuracy of 91-100\% depending on the selected task. In contrast, the model which performed the best on deepfake speech detection (baseline) was SpecRNet with a TPR of 0.66 and accuracy of 71\% when the FPR=0.01. Therefore, DFAABP significantly outperforms the baseline and provides a good defense against RT-DFs audio calls.

As mentioned in the introduction, the same DFAABP system outlined in this paper can be applied to video-based RT-DFs as well. For example, to prevent imposters from joining online meetings the DFAABP system can forward suspicious calls to a DFAABP system. There are a wide variety of tasks which existing models and pipelines cannot handle for similar reasons listed above in relation to audio calls. For example, the caller can be asked to drop/bounce objects, fold shirt, stroke hair, interact with background, spill water, pick up objects, perform hand expressions, press on face, remove glasses, turn around, and so on. These tasks can easily be turned into challenges to detect video-based RT-DFs.

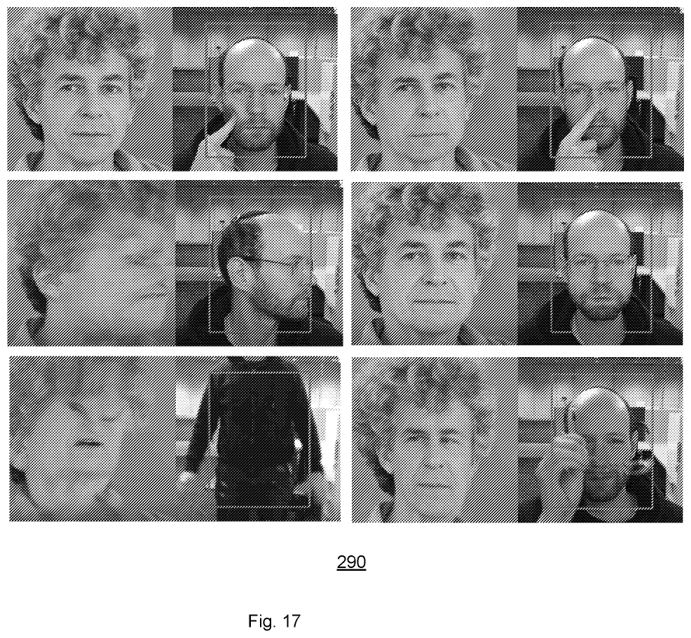

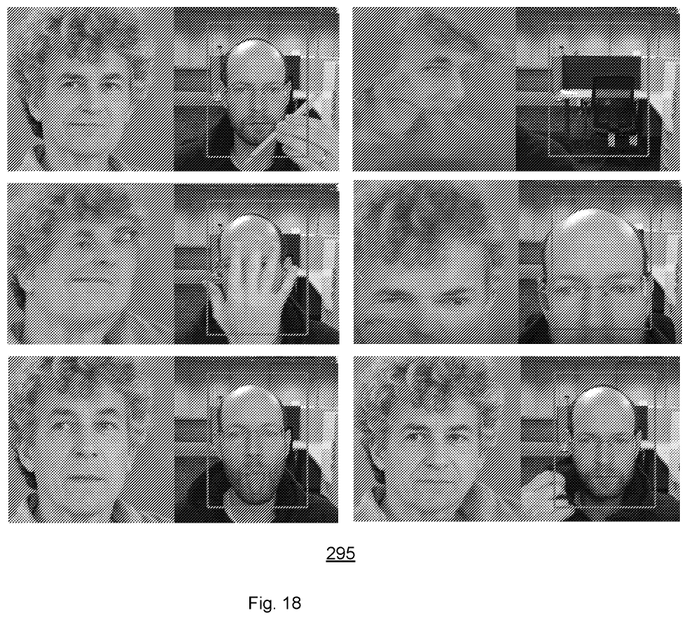

To demonstrate the potential, some initial experiments were performed to provide some preliminary results. In the experiment a popular zero-shot RT-DF model called Avatarify was used to reenact (puppet) a single photo. It provided a realistic RT-DF video at 35 frames per second (fps) with negligible distortions if the face stayed in a frontal position. However, when some of the DFAAT tasks were introduced, the model failed and large distortions appeared. FIGS. 17 and 18 present some screenshots of the video during the challenges.

These preliminary results indicate that DFAABP system can be a good solution for both RT-DF audio and video calls.

### Appendix B—Related Work and Comparison with the DFAABP

Most audio deepfake detection systems (ADDS) use a common pipeline to detect deepfake audio: given an audio clip a, the pipeline (1) converts an into a stream of one or more audio frames a (1), . . . a (n), (2) extracts a feature representation from each frame which summarizes the frames' waveforms x(1), . . . x\hat{ }(n), and then (3) passes the frame(s) through a detector which predicts the likelihood of a being real or fake. The audio features in x(i) are either a Short Time Fourier Transform (STFT), spectrogram, Mel Frequency Cepstral Coefficients (MFCC), or the Constant Q Cepstral Coefficients (CQCC) of a (i). Some methods simply use the actual waveform of a (i).

With this representation, an ADDS can either use a classifier or anomality detector to identify generated audio. In general, classifiers are trained on labeled audio data consisting of two classes: real and deepfake. By providing labeled data, the model can automatically identify the relevant features (semantic or latent) during training. An intuitive example is the case where a deepfake voice cannot accurately pronounce the letter ‘B’. In this scenario, the model will consider this pattern as a distinguishing feature for that deepfake. A disadvantage of classifiers is that they follow a closed-world assumption; that all examples of the deepfake class are in the training set. This assumption requires that detectors be retrained whenever new technologies are released.

As for the model, some works use classical machine learning models such as SVMs and decision trees while the majority use deep learning architectures such as DNNs, CNNs, and RNNs.

To improve generalization to new deepfakes, some approaches try to train on a diverse set of deepfake datasets. However, even with this strategy, ADDS systems still generalize poorly to new audio distributions recorded in new environments and to novel deepfake new technologies.

In contrast to classifiers, anomality detectors are trained on real voice data only and flag audio that has abnormal patterns within it. One approach for anomality detection is to use the embeddings from a voice recognition model to compare the similarity between real and authentic voices. Other approaches use one-class machine learning models such as OC-SVMs and statistical models such as Gaussian Mixture Models (GMM).

What's common with the above defenses is that they are all passive defenses. This means that they analyze a but they do not interact with the caller to reveal the true nature of a. In contrast, our proposed method is active in that it can force f to try and create content it is not capable of doing. By ‘pressing’ on the limitations of f, f was caused to generate audio with significantly larger artifacts, making it easier for us to detect using classifiers and anomality detection. The DFAABP system may also ensure some longevity since the attacker cannot easily overcome the limitations our challenges pose and/or because it is easy to add challenges but hard to evade them.

Another advantage of the DFAABP system compared to others is that the DFAABP system may know exactly where the anomality should be in the media stream (due to the challenge response nature of the CAPTCHA protocol). This means that the DFAABP system is more efficient since it only needs to execute its models over specific segments and not entire streams. For systems that use a fixed size of seconds from the segment, it has already been proven that reducing the input size causes a decrease in model performance.

In rtCAPTCHA the authors perform liveliness detection by (1: challenge) asking the caller to read out a text CAPTCHA, (2: response) verifying that the CAPTCHA was read back correctly, and (3: robustness) verifying that the face and voice match an existing user in a database. The concept of rtCAPTCHA is that the system assumes that the attacker will not be able to generate a response with the target's face and voice in real-time—as the system assumes that the entire response is entered then the entire response is generated. Meaning they assume that attackers must have a 2× factor of delay to convert content (3 seconds audio will come out only 3+ seconds later). However, with the advent of RT-DFs, this rtCAPTCHA can easily be bypassed since the human attacker can read the text CAPTCHA back through f_t. Moreover, our DFAABP defense does not require users to register in advance, making the solution widely applicable to many users and scenarios. Furthermore—the rtCAPTCHA solution is based solely on the significant delay between a sending of the challenge and a time till a response is received-whereas a significant delay may not exist in current real time audio deepfakers.

This application provides a significant technical improvement over the prior art-especially an improvement in computer science.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method-respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for preventing fake calls, the method comprising:
(a) receiving a call from a caller;
(b) requesting the caller to execute a deep-fake algorithm anomality triggering (DFAAT) task;
(c) receiving a caller related response to the DFAAT task;
(d) determining, based on the caller related response, whether the call is a legitimate call or a fake call; wherein the determining comprises searching for one or more deep-fake algorithm anomalies associated with the DFAAT task;
(e) performing a fake call response when determining that the call is a fake call; and
(f) performing a legitimate call response when the determining that the call is a legitimate call.

2. The method according to claim 1, comprising performing multiple iterations of steps (b)-(c).

3. The method according to claim 2, wherein different iterations are associated with different DFAAT tasks.

4. The method according to claim 2, wherein at least two of the different DFAAT tasks are tailored to trigger one or more anomalies of different deep-fake algorithms.

5. The method according to claim 2, comprising performing multiple iterations of steps (b)-(c) when finding that the call is suspected as a fake call but it not definitely a fake call.

6. The method according to claim 1, wherein the searching comprises ignoring at least one caller related response portion that is not expected to include a deep-fake algorithm anomality.

7. The method according to claim 1, wherein the determining comprises checking a fulfillment of a realism of response constraint.

8. The method according to claim 7, comprising checking of the fulfillment of the realism constraint without using previously recorded audio or video.

9. The method according to claim 7, wherein the determining further comprises checking a fulfillment at least one additional constraints selected out of a start of response constraint, an identity of the caller constraint, or a task constraint.

10. The method according to claim 7, wherein the determining further comprises checking a fulfillment of a start of response constraint, an identity of the caller constraint and a task constraint.

11. The method according to claim 7, wherein the checking of the fulfillment of the realism constraint is executed by a realism constraint machine learning process.

12. The method according to claim 7, wherein the determining further comprises checking a fulfillment of an identity of the caller constraint by comparing between (i) an identity of the caller before starting the task, to (ii) an identity of the caller during the caller related response.

13. The method according to claim 1, wherein the determining comprises sequentially determining a fulfillment of constraints, stopping the sequentially determining and declaring the call to be a fake call upon a first non-fulfillment of one of the constraints.

14. The method according to claim 1, wherein the fake call response comprises terminating the call and wherein a legitimate call response comprises enabling a reception of the call by an intended recipient of the call.

15. The method according to claim 1, wherein the fake call response comprises marking the caller as a fake call source.

16. The method according to claim 1, wherein the DFAAT task comprises clearing a throat of the caller.

17. The method according to claim 1, wherein the DFAAT task comprises humming a tune defined in the DFAAT task.

18. The method according to claim 1, wherein the DFAAT task comprises laughing.

19. The method according to claim 1, wherein the DFAAT task comprises singing a song defined in the DFAAT task.

20. The method according to claim 1, wherein the DFAAT task comprises turning around in a manner defined in the DFAAT task.

21. The method according to claim 1, wherein the DFAAT task comprises interacting with an object in a manner defined in the DFAAT task.

22. The method according to claim 1, wherein the DFAAT task comprises contacting a body part in a manner defined in the DFAAT task.

23. The method according to claim 1, wherein the call is an audio call.

24. The method according to claim 1, wherein the call is an audio-visual call.

25. The method according to claim 1, wherein the call is a visual call.

26. A non-transitory computer readable medium for preventing fake calls, the non-transitory computer readable medium stores instructions that once executed by a computerized unit to:
(a) receive a call from a caller:
(b) request the caller to execute a deep-fake algorithm anomality triggering (DFAAT) task;
(c) receive a caller related response to the DFAAT task;
(d) determine, based on the caller related response, whether the call is a legitimate call or a fake call; wherein a determining comprises searching for one or more deep-fake algorithm anomalies associated with the DFAAT task;
(g) perform a fake call response when determining that the call is a fake call; and
(h) perform a legitimate call response when the determining that the call is a legitimate call.

27. A computerized system for preventing fake calls, the computerized system comprises:
(a) an input unit that is configured to receive a call from a caller;
(b) an output unit that is configured to request the caller to execute a deep-fake algorithm anomality triggering (DFAAT) task;
(c) a processing unit that is configured to determine, based on a caller related response that is received by the input unit, whether the call is a legitimate call or a fake call;
wherein the determining comprises searching for one or more deep-fake algorithm anomalies associated with the DFAAT task; and
(d) a response unit that is configured to:
a. perform a fake call response when determining that the call is a fake call; and
b. perform a legitimate call response when determining that the call is a legitimate call.

28. A method for preventing fake calls, the method comprising:
(a) receiving a call from a caller;
(b) requesting the caller to execute a deep-fake algorithm anomality triggering (DFAAT) task;
(c) receiving a caller related response to the DFAAT task;
(d) performing at least one part of a determining, based on the caller related response, whether the call is a legitimate call or a fake call; wherein the determining comprises searching for one or more deep-fake algorithm anomalies associated with the DFAAT task;
(e) requesting another party to perform at least one other part of the determining, based on the caller related response, whether the call is the legitimate call or the fake call, wherein the determining comprises searching for one or more deep-fake algorithm anomalies associated with the DFAAT task, and receiving a response from the other party;
(f) performing a fake call response when determining that the call is a fake call; and
(g) performing a legitimate call response when the determining that the call is a legitimate call.

29. A method for preventing fake calls, the method comprising:
(a) receiving a call from a caller;
(b) requesting the caller to execute a deep-fake algorithm anomality triggering (DFAAT) task;
(c) receiving a caller related response to the DFAAT task;
(d) requesting another party to perform a determining, based on the caller related response, whether the call is a legitimate call or a fake call, wherein the determining comprises searching for one or more deep-fake algorithm anomalies associated with the DFAAT task;
(e) receiving a response from the other party;
(f) determining, based on the caller related response, whether the call is a legitimate call or a fake call;
(g) performing a fake call response when determining that the call is a fake call; and
(h) performing a legitimate call response when the determining that the call is a legitimate call.
